(19) United States
(12) Patent Application Publication
(10) Pub. No.: US 2024/0342695 A1
(43) Pub. Date: Oct. 17, 2024

(54) TEMPERATURE-CONTROLLED PHOTOCATALYTIC AND OTHER CHEMICAL REACTIONS

(71) Applicant: The Regents of the University of Michigan, Ann Arbor, MI (US)

(72) Inventors: Peng Zhou, Ann Arbor, MI (US); Zetian Mi, Ann Arbor, MI (US)

(21) Appl. No.: 18/294,641

(22) PCT Filed: Aug. 2, 2022
(86) PCT No.: PCT/US2022/039128

§ 371 Date: Feb. 2, 2024

Related U.S. Application Data
(60) Provisional application No. 63/228,467, filed on Aug. 2, 2021.

(51) Int. Cl. B01J 35/39; B01J 19/00; B01J 19/12; B01J 23/26; B01J 23/46; B01J 35/00; B01J 35/30; B01J 35/33; B01J 35/45; B01J 35/53; B01J 35/58; B01J 37/34

(52) U.S. Cl. CPC B01J 35/39; B01J 19/0013; B01J 19/127; B01J 23/26; B01J 23/464; B01J 35/19; B01J 35/33; B01J 35/397; B01J 35/398; B01J 35/45; B01J 35/53; B01J 35/58; B01J 37/345; B01J 2219/00144; B01J 2219/00155; B01J 2219/0892

(57) ABSTRACT

A method of promoting a chemical reaction includes immersing a device in a solution contained in a reaction chamber, the device including a substrate and a plurality of conductive projections supported by the substrate, each conductive projection of the plurality of conductive projections having a semiconductor composition, irradiating the device to drive the chemical reaction, and controlling a temperature of the solution contained in the reaction chamber such that the temperature is maintained in a temperature range closer to a boiling temperature of the solution than a freezing temperature of the solution

### CROSS-REFERENCE TO RELATED APPLICATION

This application claims the benefit of U.S. provisional application entitled “Temperature-Controlled Photocatalytic and Other Chemical Reactions,” filed Aug. 2, 2021, and assigned Ser. No. 63/228,467, the entire disclosure of which is hereby expressly incorporated by reference.

### STATEMENT REGARDING FEDERALLY SPONSORED RESEARCH OR DEVELOPMENT

This invention was made with government support under Contract No. 1804458 awarded by the National Science Foundation and under Contract No. W56HZV-20-C-0025 awarded by the Department of Defense. The government has certain rights in the invention.

### BACKGROUND OF THE DISCLOSURE

### Field of the Disclosure

The disclosure relates generally to photocatalytic water splitting and other chemical reactions.

### Brief Description of Related Technology

Bias-free unassisted photocatalytic overall water splitting (OWS) into hydrogen and oxygen at a stoichiometric ratio of 2:1 is desirable for the long-term clean, renewable, and sustainable fuel production in the Earth. However, the narrow visible-light response range, severe photogenerated electron-hole recombination, and high surface catalytic overpotential lead to a limited solar-to-hydrogen (STH) efficiency (e.g., less than about 3%) in most reported photocatalytic systems, which impedes the practical application of photocatalytic solar hydrogen production. Though an efficiency of approximately 100% has been reported under ultraviolet light (350-360 nm) illumination of aluminum-doped strontium titanate, the total content of ultraviolet light (300-400 nm) in the natural solar spectrum on the ground is less than 3%.

Currently reported visible-light responsive catalysts are generally restricted to 400-485 nm with limited energy conversion efficiency. Many of these photocatalysts, such as g-C₃N₄ and CdS, suffer from low crystallinity and extensive defects, which increase the recombination of photogenerated electrons and holes. Hence, developing an efficient visible-light-responsive photocatalyst is significant for the practical application of solar hydrogen.

Recently, InGaN/GaN nanowire photocatalysts with high crystallinity have been controllably grown on commercial silicon wafers using molecular beam epitaxy (MBE). The InGaN/GaN nanowire photocatalysts have shown a wide visible-light response range (400-700 nm) and suitable band-edge potentials for OWS. Significant progress has been made on tuning the surface band structure, internal electric field, and cocatalysts to improve the solar-to-hydrogen (STH) efficiency.

### SUMMARY OF THE DISCLOSURE

In accordance with one aspect of the disclosure, a method of promoting a chemical reaction includes immersing a device in a solution contained in a reaction chamber, the device including a substrate and a plurality of conductive projections supported by the substrate, each conductive projection of the plurality of conductive projections having a semiconductor composition, irradiating the device to drive the chemical reaction, and controlling a temperature of the solution contained in the reaction chamber such that the temperature is maintained in a temperature range closer to a boiling temperature of the solution than a freezing temperature of the solution.

In accordance with another aspect of the disclosure, a method of promoting a chemical reaction includes immersing a device in a solution contained in a reaction chamber, the device including a substrate and a plurality of conductive projections supported by the substrate, each conductive projection of the plurality of conductive projections having a semiconductor composition, irradiating the device with solar radiation to drive the chemical reaction, and heating the solution contained in the reaction chamber with the solar radiation.

In accordance with yet another aspect of the disclosure, a system for promoting a chemical reaction includes a reaction chamber, a device disposed in the reaction chamber, the device being configured for driving the chemical reaction upon immersion in a solution contained in the reaction chamber, the device including a substrate and a plurality of conductive projections supported by the substrate, each conductive projection of the plurality of conductive projections having a semiconductor composition, and a lens device configured to focus solar radiation on the device, on the reaction chamber, or on both the device and the reaction chamber, to heat the solution contained in the reaction chamber.

In accordance with still yet another aspect of the disclosure, a system for promoting a chemical reaction includes a reaction chamber, a device disposed in the reaction chamber, the device being configured for driving the chemical reaction upon immersion in a solution contained in the reaction chamber, the device including a substrate and a plurality of conductive projections supported by the substrate, each conductive projection of the plurality of conductive projections having a semiconductor composition, and a thermal transfer control device configured to implement a thermal energy transfer procedure to control a temperature of the solution contained in the reaction chamber such that the temperature is maintained in a temperature range closer to a boiling temperature of the solution than a freezing temperature of the solution.

In accordance with still another aspect of the disclosure, a method of hydrogen production via water splitting includes immersing a photocatalytic device in a solution contained in a reaction chamber, the photocatalytic device including a substrate and a plurality of conductive projections supported by the substrate, each conductive projection of the plurality of conductive projections having a semiconductor composition, the solution including water, irradiating the photocatalytic device to drive the water splitting of the water of the solution contained in the reaction chamber, and controlling a temperature of the solution contained in the reaction chamber such that the temperature is maintained in a temperature range closer to a boiling temperature of the solution than a freezing temperature of the solution.

In connection with any one of the aforementioned aspects, the systems, devices and/or methods described herein may alternatively or additionally include or involve any combination of one or more of the following aspects or features. The chemical reaction includes a photocatalytic reaction. The device is configured as a photocatalytic device to drive the photocatalytic reaction. Irradiating the device includes directing solar radiation to the device, and controlling the temperature includes directing the solar radiation to the device. Controlling the temperature includes focusing solar radiation. Controlling the temperature includes disposing a support stand on which the device rests in a focal plane of a lens device. Controlling the temperature includes circulating heated water into the reaction chamber. Controlling the temperature includes implementing a thermal energy transfer procedure. The reaction chamber is thermally insulated. The solution includes water and the temperature range falls between about 60 degrees Celsius and 80 degrees Celsius. The solution includes water and the temperature range falls between about 70 degrees Celsius and about 75 degrees Celsius. Each conductive projection of the plurality of conductive projections includes a nanowire, and the semiconductor composition includes indium gallium nitride doped with magnesium. The device further includes first and second pluralities of catalyst nanoparticles disposed over each conductive projection of the plurality of conductive projections. Each catalyst nanoparticle of the first plurality of catalyst nanoparticles includes cobalt oxide. Each catalyst nanoparticle of the second plurality of catalyst nanoparticles includes a core and shell surrounding the Rh core. The core includes rhodium (Rh) core and the shell includes chromium oxide. The chemical reaction includes a photocatalytic reaction, and the device is configured as a photocatalytic device to drive the photocatalytic reaction. Heating the solution includes controlling a temperature of the solution contained in the reaction chamber such that the temperature is maintained in a temperature range closer to a boiling temperature of the solution than a freezing temperature of the solution. The solution includes water and the temperature range falls between about 60 degrees Celsius and 80 degrees Celsius. Heating the solution includes focusing the solar radiation on the reaction chamber. Each conductive projection of the plurality of conductive projections includes a nanowire, the semiconductor composition includes indium gallium nitride doped with magnesium, the device further includes first and second pluralities of catalyst nanoparticles disposed over each nanowire, each catalyst nanoparticle of the first plurality of catalyst nanoparticles includes cobalt oxide, each catalyst nanoparticle of the second plurality of catalyst nanoparticles includes a core and shell surrounding the Rh core, and the core includes rhodium (Rh) core and the shell includes chromium oxide. The chemical reaction includes a photocatalytic reaction, the device is configured as a photocatalytic device to drive the photocatalytic reaction, and the lens device is configured to focus the solar radiation on the device to drive the photocatalytic reaction. The reaction chamber is thermally insulated. The reaction chamber includes a support stand on which the device is disposed, and the lens device is configured to focus the solar radiation on the support stand to heat the solution contained in the reaction chamber. The system further includes a lens device configured to focus solar radiation on the device, on the reaction chamber, or on both the device and the reaction chamber, to heat the solution contained in the reaction chamber. The chemical reaction includes a photocatalytic reaction, the device is configured as a photocatalytic device to drive the photocatalytic reaction, and the lens device is configured to focus the solar radiation on the device to drive the photocatalytic reaction.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts (a) a 45-degree tilted field emission scanning electron microscopy (FESEM) image of an array of InGaN/GaN nanowires in accordance with one example, along with (b) a graphical plot of an X-ray diffraction (XRD) pattern of the nanowires, (c) a scanning transmission electron microscopy (STEM) image of an InGaN/GaN heterostructure of one of the nanowires, (d) a high-resolution transmission electron microscopy (HRTEM) image of Rh/Cr₂O₃/Co₃O₄ cocatalyst nanoparticles supported by one of the nanowires, and (e) a STEM and element mapping of a Rh/Cr₂O₃/Co₃O₄-loaded InGaN/GaN nanowire.

FIG. 2 depicts (a) a graphical plot of solar-to-hydrogen (STH) efficiency as a function of temperature of a photocatalytic device in accordance with one example, along with (b) a graphical plot of STH efficiency over time during a stability test of a photocatalytic device in accordance with one example, (c) a graphical plot of hydrogen concentration over time in experiments for a number of temperatures, and (d) a schematic view of the operation of a photocatalytic device in accordance with one example.

FIG. 3 depicts (a) a graphical plot of gas production from tap water by a photocatalytic device in accordance with one example during irradiation by simulated solar light from a 300 W Xe lamp equipped with a AM1.5G filter, along with (b) a graphical plot of gas production by a photocatalytic device in accordance with one example during irradiation by concentrated natural solar light (about 16,070 mW cm⁻²).

FIG. 4 is a schematic view of a temperature-controllable photocatalytic overall water splitting (OWS) system in accordance with one example in which a double-layer chamber implements the temperature-controllable photocatalytic OWS and circulating water is provided by a circulator (e.g., a heated circulator) to control the temperature of the reaction chamber.

FIG. 5 is a schematic view of a temperature-controllable photocatalytic overall water splitting (OWS) system in accordance with another example in which a reaction chamber is thermally insulated to control the temperature of the reaction chamber.

FIG. 6 is a schematic view of a photocatalytic overall water splitting (OWS) system in accordance with one example in which natural solar radiation is focused to increase an intensity of the solar radiation.

FIG. 7 is a flow diagram of a method for photocatalytic water splitting with temperature control in accordance with one example.

FIG. 8 is a schematic diagram of a system for photocatalytic water splitting with temperature control in accordance with one example.

The embodiments of the disclosed systems, devices and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Systems, devices, and methods for temperature-controlled chemical reactions are described. The chemical reactions may be photocatalytic reactions, such as water splitting. The temperature control of the disclosed systems, methods and devices allows an optimal or otherwise suitable or useful reaction temperature to be maintained or established for the water splitting or other chemical reaction. In water splitting examples, the reaction temperature is controlled and maintained at a level such that an increase in solar-to-hydrogen (STH) efficiency is achieved. The temperature-dependent strategy utilized by the disclosed systems, devices, and methods leads to STH efficiencies of about 7% from tap water and seawater. In one example, an STH efficiency of greater than 9% (e.g., 9.17%) was achieved in unassisted (e.g., bias-free) photocatalytic overall water splitting (OWS).

In some cases, the reaction temperature is maintained or established by heating water (e.g., pure, tap, sea or other water) or other solution (e.g., an electrolyte including water) in the reaction chamber with solar radiation that irradiates a photocatalytic device to drive the photocatalytic water splitting. The solar radiation may be focused to increase an intensity of the irradiation.

About 40% of solar light lies in the visible spectrum (400-700 nm), which can theoretically contribute to a STH of 24% in photocatalytic OWS. Besides the ultraviolet and visible light, the content of infrared light in solar spectrum reaches up to 50%. Infrared light, however, cannot directly photo-excite the catalytic elements of the devices to produce electrons and holes with sufficient energy to drive OWS, which limits the maximum achievable STH efficiency in photocatalytic OWS. In contrast, the disclosed systems, methods and devices are capable of utilizing the full solar spectrum in photocatalytic OWS to significantly improve STH efficiency. As shown in the examples described herein, a desired reaction temperature is achieved by harvesting the previously wasted infrared light of the solar spectrum in a reaction chamber. The reaction temperature may thus be achieved without reliance on other energy consumption. In some cases, a thermal insulation layer may be used to attain and maintain a desired reaction temperature via the light-based energy.

Although described herein in connection with water splitting, the disclosed devices and systems are not limited to water splitting or the production of hydrogen. The disclosed devices and systems may be useful in connection with other chemical reactions, including, for instance, CO₂ reduction, methane oxidation to methanol (CH₄+H₂O=H₂+CH₃OH) and nitrogen reduction to ammonia (2N₂+6H₂O=4NH₃+3O₂).

The disclosed systems, methods, and devices are useful in connection with photocatalytic reactions and non-photocatalytic reactions. As used herein, the term “photocatalytic reaction” is used broadly to refer to reactions catalyzed by photogenerated charge carriers either with or without additional assistance (e.g., energy provided to promote the reaction in addition to the light generating the charge carriers). Examples of such additional assistance to promote the reaction include electrical assistance (e.g., a bias voltage applied in a photoelectrochemical reaction) and thermal assistance. Examples involving non-photocatalytic reactions do not use incident light to generate charge carriers to catalyze the reaction. In such cases, the charge carriers may be provided in various ways, including, for instance, electrically via a bias voltage.

Although described herein in connection with electrodes having visible-light-responsive GaN-based nanowire arrays (e.g., InGaN nanowires) for water splitting, the disclosed devices and systems are not limited to GaN-based nanowire arrays. A wide variety of other types of nanostructures and other conductive projections may be used. For instance, the conductive projections may be oriented upright or extend outward from a substrate, and/or may not be arranged in an array. Thus, the nature, construction, orientation, configuration, characteristics, shape, and other aspects of the conductive projections through which the water splitting or other reaction is implemented may vary from the examples described herein.

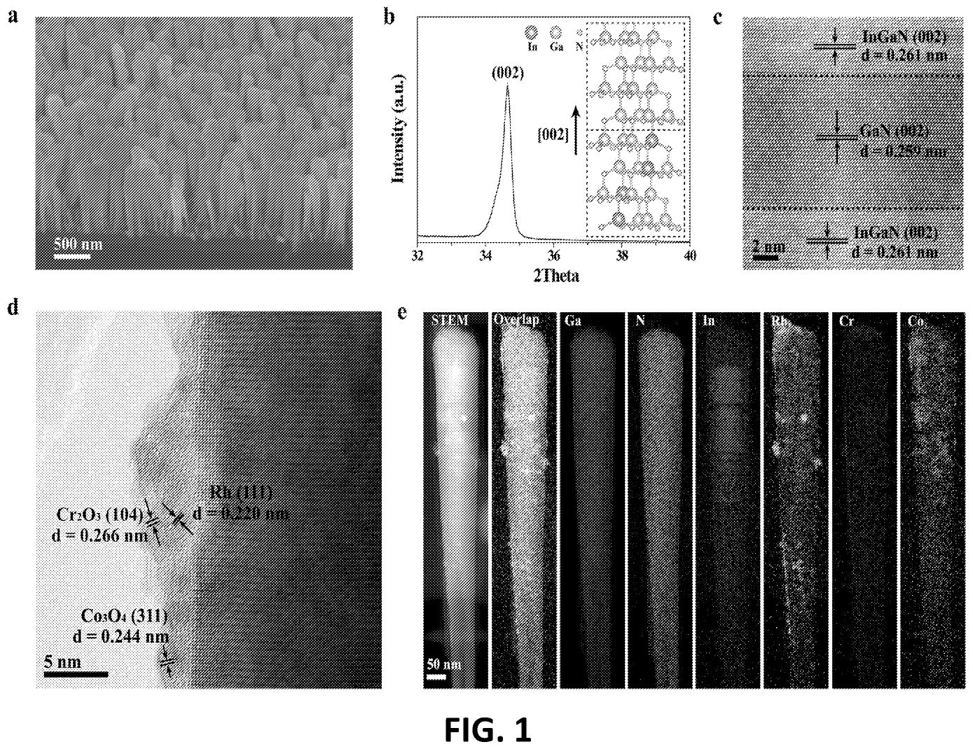

The characterization, performance, and other aspects of a number of examples of the disclosed systems, methods and devices are now described in connection with FIGS. 1-3. In these cases, the photocatalytic devices include an array of InGaN nanowires. During operation, the arrays of the examples are irradiated by either simulated, unfocused, or focused solar radiation, as described below.

In one example, an STH efficiency of about 9.17% was achieved using an array of InGaN/GaN nanowires loaded with a Rh/Cr₂O₃/Co₃O₄ catalyst arrangement (which may be referred to herein as “Rh/Cr₂O₃/Co₃O₄—InGaN/GaN nanowires”). The efficiency was achieved via the synergistic effects of promoting the forward hydrogen-oxygen evolution reaction and inhibiting the reverse hydrogen-oxygen recombination reaction simultaneously. The synergistic effects were, in turn, achieved by utilizing infrared light of the solar spectrum to achieve a useful reaction temperature. In this case, the optimal reaction temperature fell in a range from about 70 to about 75 degrees Celsius, but other reaction temperatures may be used in other cases.

In another example, a large-scale photocatalytic OWS system utilizing the synergistic effects of promoting the forward hydrogen-oxygen evolution reaction and inhibiting the reverse hydrogen-oxygen recombination reaction achieved a STH efficiency of 6.21% under concentrated (or focused) natural solar light. While lower than that of the best reported PEC water splitting devices, this efficiency level is nearly triple the efficiency value of previously reported photocatalytic OWS devices, and exhibits significantly better stability than PEC devices. The feasibility of InGaN/GaN- and other semiconductor-based solar water splitting was thus demonstrated.

With reference now to FIG. 1, an example of a photocatalytic device having InGaN/GaN nanowires supported on a silicon wafer or other substrate was fabricated by molecular beam epitaxy (MBE). A field emission scanning electron microscopy (FESEM) image shows the well-arrayed InGaN/GaN nanowires with a length of about 1.2 μm on the silicon wafer, as shown in Part a of FIG. 1. As shown in Part b of FIG. 1, an X-ray diffraction (XRD) pattern suggests the high crystallinity of the InGaN/GaN nanowires. In this example, the nanowires were grown along the direction according to the PDF card (2-1078) of Ga(In)N. This was further confirmed by high-angle annular dark-field scanning transmission electron microscopy (HAADF-STEM) shown in Part c of FIG. 1.

In the example of FIG. 1, each nanowire includes a heterostructure including a number of semiconductor segments, e.g., III-nitride layers or segments. One or more clear interfaces (see dashed lines in the image of Part c of FIG. 1) between GaN and InGaN indicates the controllable atomic configuration in the growth of the InGaN/GaN heterostructures.

Part d of FIG. 1 depicts an arrangement of Rh/Cr₂O₃ core/shell and Co₃O₄ nanoparticles loaded or disposed on the InGaN/GaN nanowires. The nanoparticles may be deposited on the nanowires using a photo-deposition method. The Rh/Cr₂O₃ core/shell and Co₃O₄ nanoparticles are configured to act as cocatalysts for the hydrogen and oxygen production, respectively. The FESEM image depicted in Part d of FIG. 1 shows the InGaN/GaN nanowires following the photo-deposition. The FESEM image indicates that the loading of cocatalysts produced little effect on the aligning of InGaN/GaN nanowires on the silicon wafer.

Part e of FIG. 1 depicts energy dispersive X-ray (EDS) elemental mapping analysis to show the distribution of Rh, Cr and Co on the InGaN/GaN nanowires. The distribution of indium in the InGaN/GaN nanowires varied along with the growth direction, leading to a large variation of the energy bandgap. For example, the In content may vary and fall within a range from about 0.09 to about 0.40. The distribution of indium was further confirmed by SEM-cathodoluminescence (SEM-CL) measurements. In this example, the different band gaps in the InGaN nanostructures ranged from 445 nm to 545 nm, thereby establishing a visible light response of the InGaN/GaN nanowires. UV-vis diffuse reflectance spectroscopy (DRS) was used to show the light response in the full visible spectrum, which showed three peaks at 408 nm, 494 nm and 632 nm. Theoretically, the band gap of 632 nm may contribute to a maximum STH efficiency of 17.69% under natural solar light and 31.06% under simulated solar light from a Xe lamp with the incorporation of an AM1.5G filter.

As described further herein in connection with a number of examples, the varying indium content may establish a multi-band structure. The conduction band-edge potential of the InGaN nanowires decreased with indium content, while the valence band-edge potential was increased with indium content. The multi-band structure is useful for increasing (e.g., maximizing) redox ability of photogenerated electrons and holes, which may accelerate the rate of photocatalytic reaction. Based on the band diagrams, the different InGaN segments in the structure do not form a heterojunction or Z-scheme charge transfer. Instead, the different InGaN segments work independently in the charge carrier separation and/or transfer. For instance, the band gap corresponding to 632 nm could theoretically contribute to a maximum STH of 17.7% under natural solar light and 31.1% under simulated solar light from Xe lamp with the incorporation of an AM1.5G filter.

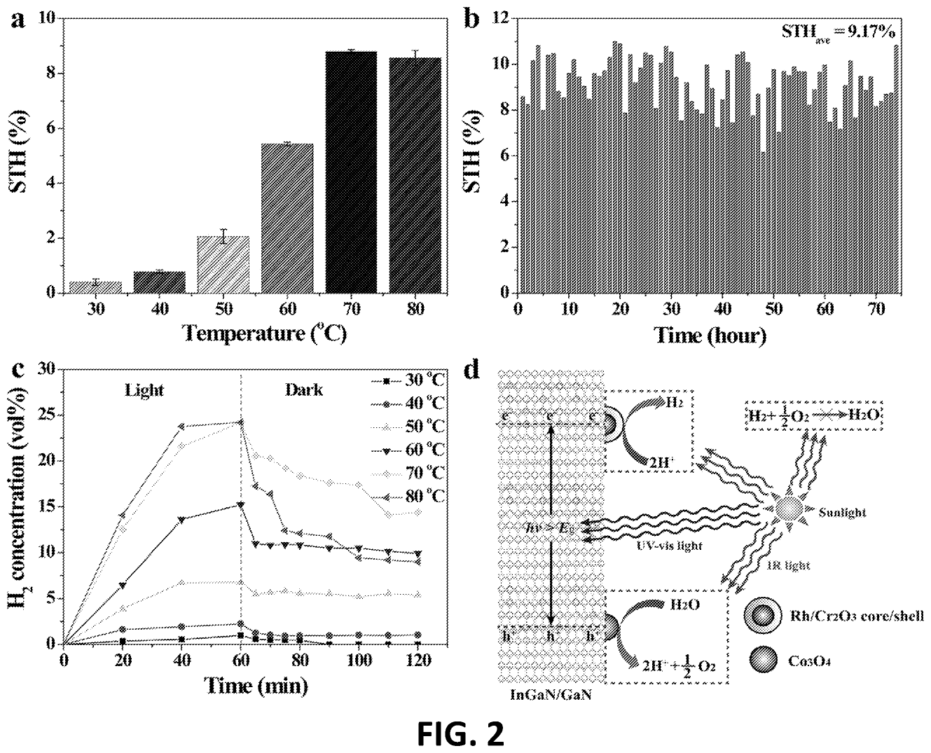

FIG. 2 depicts the effects of operation of a photocatalytic device, such as the photocatalytic device of FIG. 1, at various reaction temperatures. In this example, the photocatalytic device included an array of Rh/Cr₂O₃/Co₃O₄-loaded InGaN/GaN nanowires. The photocatalytic device was operated in a temperature-controlled photocatalytic system to perform OWS in pure water at different temperatures ranging from 30 degrees Celsius to 80 degrees Celsius under concentrated simulated solar light (3800 mW cm⁻²). As shown in part a of FIG. 2, the STH efficiency of the Rh/Cr₂O₃/Co₃O₄-loaded InGaN/GaN nanowires showed an unexpected dependence on the operating temperature of the system, increasing significantly with the temperature. The STH efficiency reached a maximum value (8.80%) at about 70 degrees Celsius. However, further increasing temperature to about 80 degrees Celsius did not improve the STH efficiency. Further testing at 70 degrees Celsius but at varying light intensities showed that STH efficiency was not improved with light intensities larger than 13 suns. Hence, the reaction temperature is a useful factor or parameter in determining the STH efficiency of the photocatalytic systems, devices, and methods described herein.

The temperature dependence shown in FIG. 2 may be used to configure a photocatalytic system to optimize or otherwise improve the STH efficiency. In the example of FIG. 2, the system includes a heat insulating layer to maintain the reaction temperature. The system was configured to utilize (e.g., directly utilize) the infrared light of the solar spectrum to heat up the system, which avoided any additional energy input for controlling temperature.

FIG. 2 depicts the results of the incorporation of the heat insulating layer. The heat insulating layer enabled the system to operate at a temperature of about 70.5 degrees Celsius. In a 74-hour test, a world-record STH efficiency of 9.17% was obtained under concentrated simulated solar light (3800 mW cm⁻²) in pure water (Part b of FIG. 2). The turnover frequency (TOF) and turnover number (TON) were calculated to be 601 h⁻¹ and 44,458 in the 74-hour test, respectively, demonstrating the effective photocatalytic overall water splitting by the Rh/Cr₂O₃/Co₃O₄—InGaN/GaN nanowires. After the reaction, the crystal and array structure of the InGaN/GaN nanowires on the silicon wafer was examined and found to be stable. As a comparison, the system temperature was 50.8 degrees Celsius in the absence of the heat insulating layer, at which the system only achieved a STH efficiency of about 2-3%. These results demonstrate the feasibility and utility of the temperature control-based technique of the disclosed methods, devices, and systems for significantly improving the STH efficiency of photocatalytic devices having semiconductor heterostructures, such as Rh/Cr₂O₃/Co₃O₄—InGaN/GaN nanowires.

The manner in which the reaction temperature improves efficiency is now addressed. Increasing reaction temperature is capable of enhancing mass transfer and the chemical bond formation/breaking in the catalytic reaction, thus contributing to a higher reaction rate. Two experiments were conducted to explore this further. In the experiments, methanol was used as an electron donor and KIO₃ as an electron acceptor in photocatalytic water splitting. The experiments revealed that both the half hydrogen-production and oxygen-production rates were significantly improved with reaction temperature. However, the difference was that the oxygen-production rate was not further improved with temperatures higher than about 70 degrees Celsius. This implied that further increase of the STH efficiency with temperature was likely limited by the oxygen evolution reaction, which was considered as a rate-determining step in overall water splitting. Besides, the hydrogen-oxygen recombination acting as a common back reaction was another determining factor influencing the maximum achievable STH efficiency. Though the Rh/Cr₂O₃ core/shell structure was reported to moderately inhibit the hydrogen-oxygen recombination in the photocatalytic OWS, its behavior at different temperatures had heretofore remained unknown.

Part c of FIG. 2 shows the results of a hydrogen-oxygen recombination experiment designed to investigate the temperature effect. The stoichiometric hydrogen and oxygen were firstly produced under light irradiation at different temperatures. Then the hydrogen and oxygen were gradually decreased with time at an approximate stoichiometric ratio of 2:1 after the light was removed, implying significant hydrogen-oxygen recombination. Finally, the concentrations of hydrogen and oxygen reached a balance. Unexpectedly, the balance concentration of hydrogen and oxygen varied significantly with temperature. A higher balance concentration suggests a reduced hydrogen-oxygen recombination reaction and a stronger ability for the system to support mixed hydrogen and oxygen gas, thereby contributing to a higher level of photocatalytic OWS activity. The balance concentration of hydrogen and oxygen firstly increased with temperature and reached the highest value at about 70 degrees Celsius. However, further increasing temperature to about 80 degrees Celsius was found to enhance the recombination of hydrogen and oxygen. A higher balance content suggests a higher tolerance on hydrogen-oxygen contents, which contributes to a reduced hydrogen-oxygen recombination reaction and a stronger ability for the system to support mixed hydrogen and oxygen gas. This well explains the highest photocatalytic OWS activity at 70 degrees Celsius.

The enhancement of hydrogen-oxygen recombination at a higher temperature (80 degrees Celsius) was attributed to the improved diffusivity coefficient of hydrogen and oxygen caused by further temperature increase accelerated the mass transfer in water, which became dominant in the hydrogen-oxygen recombination reaction. Furthermore, the excessively high temperature may enhance the non-radiative recombination of photogenerated electrons and holes in the photocatalyst structure. Hence, in this example, a temperature of about 70 degrees Celsius is an optimal temperature for inhibiting hydrogen-oxygen recombination on the Rh/Cr₂O₃/Co₃O₄—InGaN/GaN nanowires in pure water, which effectively promotes hydrogen and oxygen production in photocatalytic OWS. Thus, the highest STH efficiency was obtained at about 70 degrees Celsius on Rh/Cr₂O₃/Co₃O₄—InGaN/GaN nanowires in photocatalytic OWS. The optimal temperature may vary in connection with other heterostructures and cocatalyst arrangements.

Part d of FIG. 2 shows a schematic view of photocatalytic water splitting with the temperature promotion described herein. The UV-vis light is responsible for the production of photogenerated electrons and holes via the photoexcitation of the InGaN/GaN semiconductor, which can further cause the redox of water. Though the infrared light is noneffective for the photoexcitation of InGaN/GaN, the infrared light produces a significant thermal effect to promote hydrogen/oxygen production and simultaneously inhibit the hydrogen-oxygen recombination. In this way, the infrared light significantly (albeit indirectly) improved the utilization efficiency of UV-vis light by enhancing the surface catalytic hydrogen/oxygen production, which finally contributed to maximizing the STH efficiency.

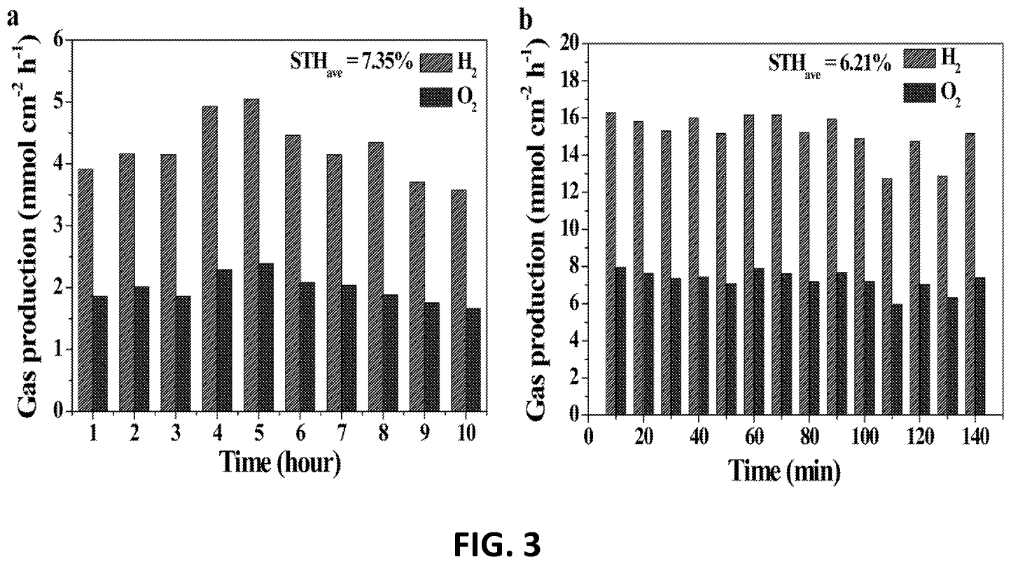

FIG. 3 depicts the results of operating a photocatalytic water splitting system in accordance with one example. The photocatalytic water splitting system was used with tap water rather than pure (or deionized) water as the water source. Shown in Part a of FIG. 3, the tap water was split into hydrogen and oxygen at the approximate stoichiometric ratio of 2:1 on the Rh/Cr₂O₃/Co₃O₄—InGaN/GaN nanowires at about 70 degrees Celsius, resulting in an STH efficiency of 7.4% in a 10-hour test. Further testing using sea water resulted in an STH efficiency of 6.6% in a 10-hour test. The testing confirmed the feasibility of directly using tap water and sea water in the photocatalytic OWS of the disclosed systems and devices. It should be noted that the ions or other impurities in tap water and sea water may reduce the activity of photocatalyst materials. Hence, the activity of the Rh/Cr₂O₃/Co₃O₄—InGaN/GaN nanowires in tap water was slightly lower than that in deionized water.

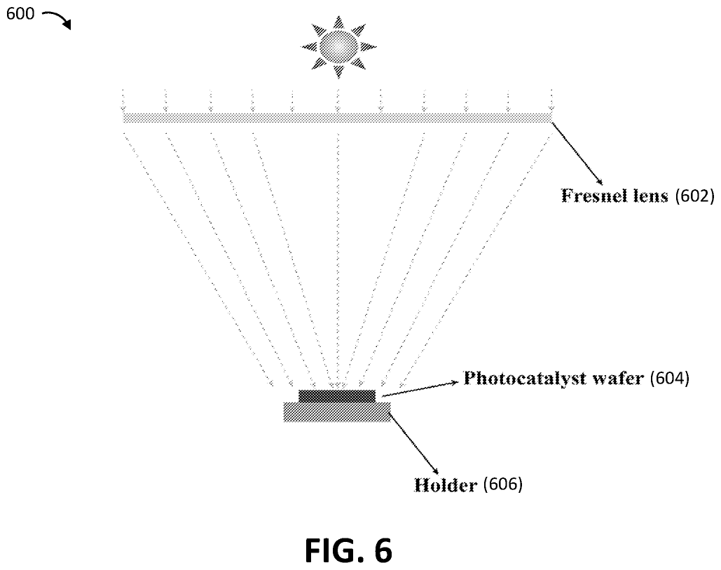

In another example, a relatively large scale photocatalytic water splitting system was also tested under natural solar light for photocatalytic OWS. The system included a Fresnel lens (e.g., having an area of about 1 m by about 1 m) to form concentrated solar light (about 16,070 mW cm⁻²) on a 4 cm by 4 cm photocatalyst wafer. The concentrated solar light led to a natural solar light capacity of 257 W. These aspects of the system are shown in the schematic, partial view of the system in FIG. 6. During the testing, the reaction chamber was heated by the high intensity of the solar light. The heat was maintained by with heat insulating layers disposed along the reaction chamber. During the outdoor photocatalytic OWS testing, the temperature of the insulated chamber reached, and was suitably maintained at, a temperature of 75±3 degrees Celsius. Operation at that temperature led to an STH efficiency of 6.21%, which is the highest value ever reported for photocatalytic water splitting under natural solar light. The hydrogen production results are shown in Part b of FIG. 3. The corresponding TOF and TON of InGaN/GaN nanowires during the outdoor testing were determined to be 24,063 h⁻¹ and 56,148 in this 140-min outdoor test, respectively, suggesting the high utilization efficiency of InGaN/GaN NWs. While the loss of partial cocatalysts led to reduced STH efficiency in the further outdoor test, this example shows the feasibility of high efficiency photocatalytic OWS using natural solar light and widely available tap water as the light source and feedstock.

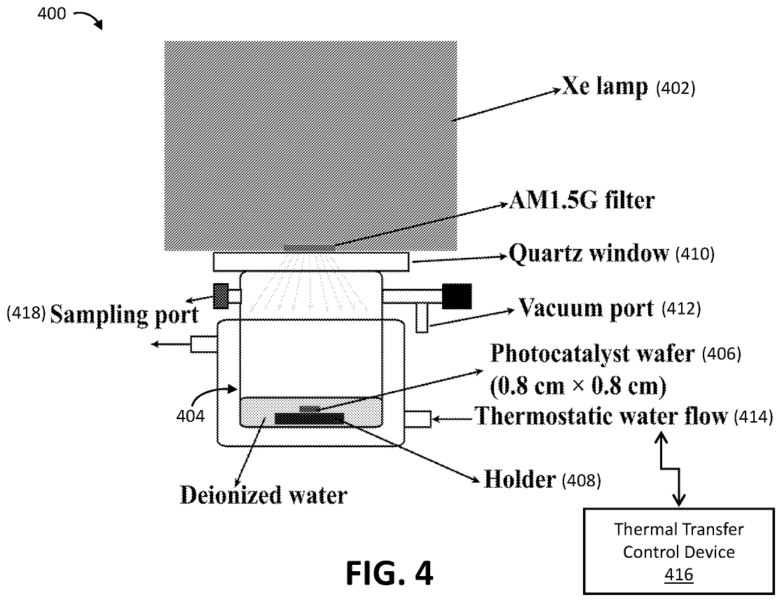

FIG. 4 depicts a photocatalytic overall water splitting system 400 in accordance with one example. The system 400 includes an Xe lamp 402 as a radiation source. The Xe lamp 402 may be configured to provide simulated solar radiation. For instance, the Xe lamp 402 may be a 300 W Xe lamp equipped with an AM1.5G filter. The system 400 includes a reaction chamber 404. In one example, the chamber 404 is or includes a 390 mL Pyrex chamber containing 50 mL of deionized water. A photocatalytic device 406 is disposed in the chamber 404. The photocatalytic device 406 may be one of the devices described herein, or another device. In one example, a 0.8 cm×0.8 cm photocatalyst wafer is loaded with Rh/Cr₂O₃ core/shell and Co₃O₄ nanoparticles and stabilized in or on a holder 408 with a volume of 10 mL. The holder 408 was installed on the bottom of chamber 404, which is covered by a vacuum-tight quartz lid 410. Before the photocatalytic reaction, the chamber 404 may be vacuumized via a vacuum port 412 as shown.

In this example, a circulating water layer is used to control the temperature of the chamber 404. For instance, a thermostatic water flow 414 may be provided as shown. The system 400 may include a thermal transfer control device 416 to control the water flow. The thermal transfer control device 416 may include or respond to one or more sensors providing a feedback signal representative of the temperature level for the reaction chamber 404, e.g., the temperature of the water in the chamber 404. Alternatively or additionally, one or more insulating devices, such as an insulating layer, may be applied to the chamber 404 to control and/or maintain the temperature. In still other cases, the chamber 404 may be configured as a double- or other multi-layer chamber.

The system 400 may include a sampling port 418 to manually sample the hydrogen and oxygen produced during operation. A vacuum-tight syringe may be applied via the sampling port 418.

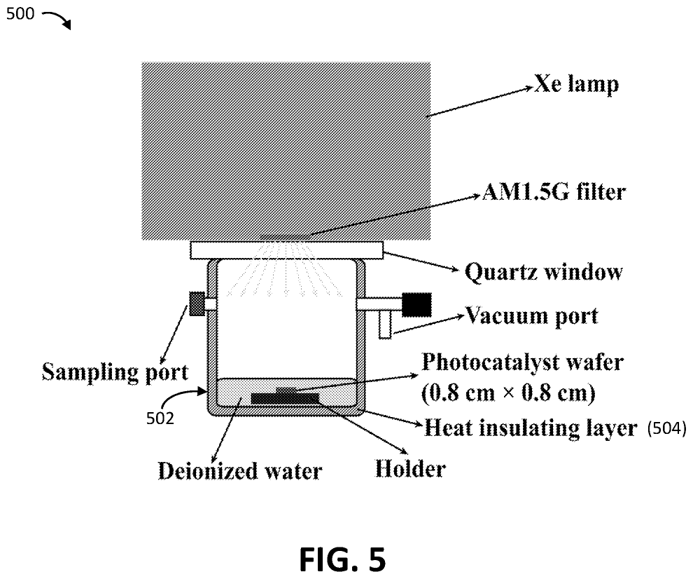

FIG. 5 depicts a photocatalytic overall water splitting system 500 (or other photocatalytic reaction system) in accordance with another example. The system 500 may have a number of features in common with the system of FIG. 4. The system 500 may differ in that a reaction chamber 502 or the system 500 includes a heat insulating layer 504 to establish and/or maintain a temperature for the reaction chamber 502. In one example, the heat insulating layer 504 has a thickness of about 0.5 cm. The heat insulating layer 504 may include a sheet of paper or a stack of paper sheets (e.g., common printer paper sheets), but alternative or additional materials or layers may be used.

In the example of FIG. 5, the system 500 is configured for self-heating. In other cases, the system 500 may include one or more components directed to thermal transfer, such as a heat exchanger.

FIG. 6 depicts a photocatalytic overall water splitting system 600 (or other photocatalytic or non-photocatalytic chemical reaction system) in accordance with yet another example. In this case, the system 600 includes a Fresnel lens 602 to focus or concentrate incoming radiation, e.g., solar radiation. A wafer 604 of a photocatalyst device of the system 600 may be located in the focal plane of the Fresnel lens 602. In this example, the wafer 604 is mounted or otherwise disposed on a holder 606. In some cases, the focused radiation may also be incident upon the holder 606 as shown, which may contribute to establishing a desired reaction temperature as described herein.

Only a portion of the system 600 is shown for ease in illustration. The system 600 may have a number of additional components or elements, including, for instance, a reaction chamber in which the device and water are disposed, as well as other elements described herein in connection with other examples.

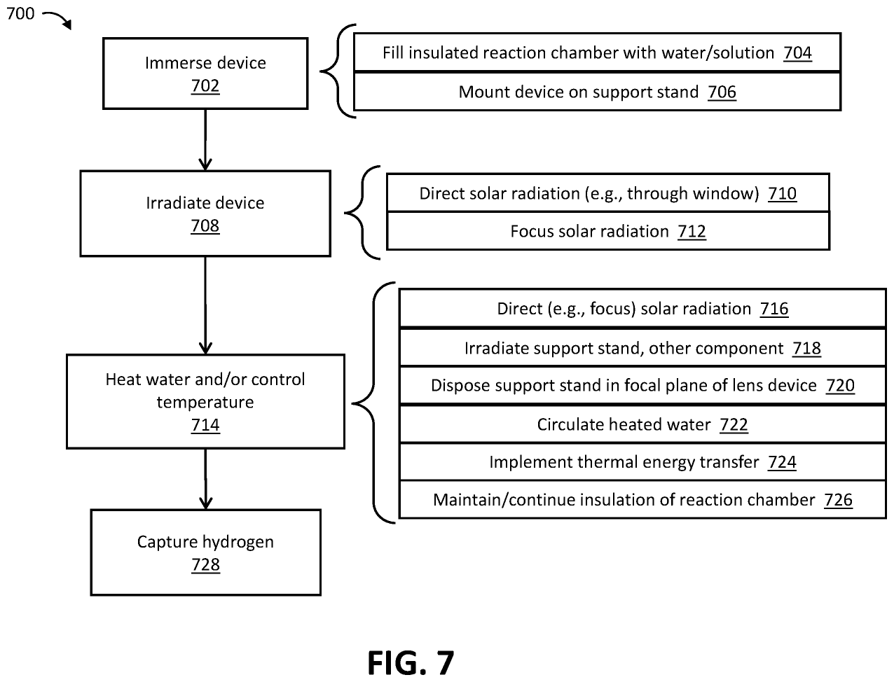

FIG. 7 depicts a method 700 for promoting a chemical reaction in accordance with one example. The chemical reaction may be photocatalytic or non-photocatalytic. In photocatalytic examples, the chemical reaction may be or otherwise include water splitting. The method 700 may be implemented using one of the devices and/or systems described herein, and/or another device or system.

The method 700 includes an act 702 in which a device (e.g., a photocatalytic device) is immersed in water (or other solution) contained in a reaction chamber. The device may be configured as described herein. For instance, the device may include a substrate and a plurality of conductive projections supported by the substrate. Each conductive projection has a semiconductor composition, such as those described herein. The act 702 may include an act 704 in which the reaction chamber (e.g., an insulated reaction chamber) is filled with water (or other solution). The act 704 may include circulating the water. Alternatively or additionally, the act 702 includes mounting or otherwise disposing the photocatalytic device on a holder or other support stand in an act 706.

In the example of FIG. 7, in an act 708, the photocatalytic device is irradiated to drive the photocatalytic water splitting. In some cases, the photocatalytic device is irradiated with solar radiation. The act 708 may include directing the solar or other radiation, e.g., through a window, opening, or transparent portion of the reaction chamber in an act 710. Alternatively or additionally, the act 708 includes focusing the radiation (e.g., solar radiation) on the photocatalytic device in an act 712.

The method 700 includes an act 714 in which the water contained in the reaction chamber is heated, and/or a temperature of the water is controlled. The heating and/or control may implemented such that the temperature is maintained in a temperature range closer to a boiling temperature (e.g., 100 degrees Celsius) of the water than a freezing temperature (e.g., 0 degrees Celsius) of the water. All temperatures within the range may be closer to the boiling temperature than the freezing temperature. Alternatively, a midpoint of the range is closer to the boiling temperature than the freezing temperature. In some cases, the temperature range falls between about 60 degrees Celsius and 80 degrees Celsius, although the range may differ in other cases. For instance, the temperature range may fall between about 70 degrees Celsius and about 75 degrees Celsius.

In some cases, the heating is implemented with or via solar radiation focused on or otherwise directed to the photocatalytic device in an act 716. Alternatively or additionally, the act 714 includes focusing the solar radiation on the support stand and/or other component of the reaction chamber in an act 718. For instance, the support stand may be disposed in a focal plane of a lens device, such as a Fresnel lens, in an act 720.

In some cases, the act 714 includes an act 722 in which water, e.g., heated water, is circulated. The water may be heated via solar radiation in any number of ways. Alternatively or additionally, the water is heated via some other source of energy. Any type of thermal energy transfer procedure may be implemented in an act 724 to heat the water and/or maintain or otherwise control the temperature of the water. The water temperature may be controlled directly or indirectly (e.g., heating of some other system component). The act 714 may include an act 726 in which insulation of the reaction chamber is maintained or continued during operation.

The method 700 may include an act 728 in which hydrogen produced in the reaction chamber is captured. The manner in which the hydrogen is captured may include accessing a port in the reaction chamber.

The method 700 may include fewer, alternative, or additional acts. For example, the method 700 may include one or more acts directed to filtering or treating the water, e.g., to remove ions and/or other impurities.

The acts may be implemented in an order other than the order shown in FIG. 7. For instance, implementation of the act 714 may be initiated before or concurrently with the irradiation of the device in the act 708.

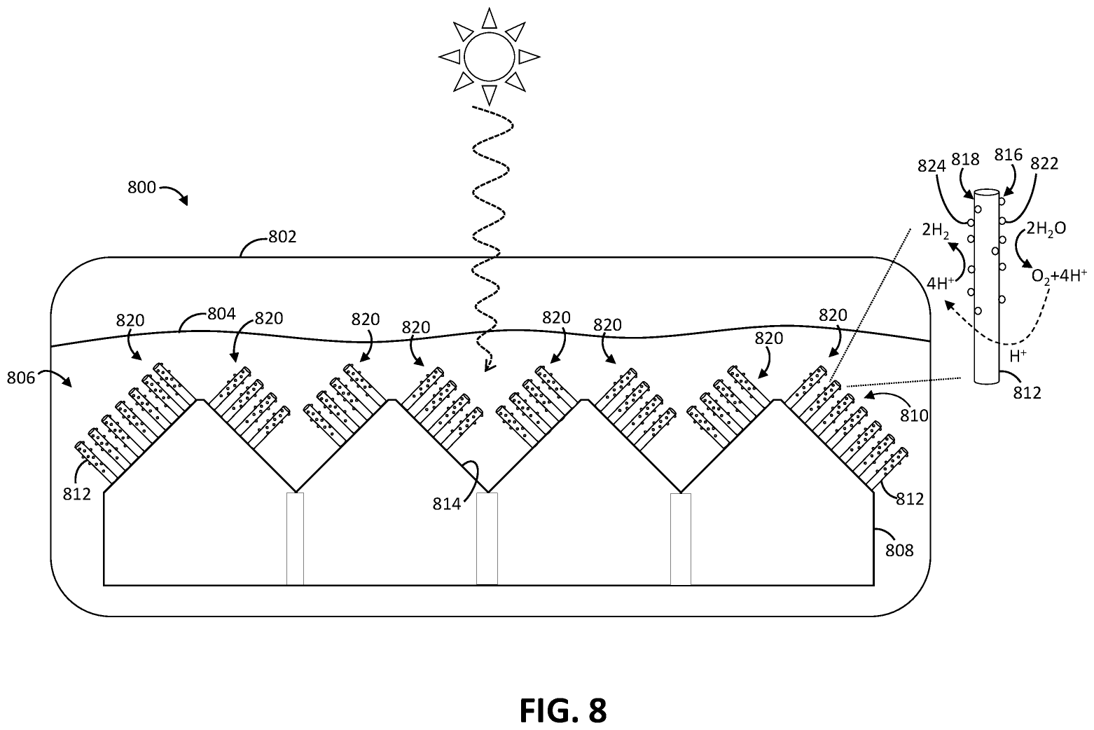

FIG. 8 depicts a system 800 for promoting a chemical reaction in accordance with one example. The system 800 may be configured to promote a photocatalytic reaction or a non-photocatalytic reaction. In photocatalytic examples, the reaction may be or otherwise include water splitting. In this example, the photocatalytic system 800 includes a container or other reaction chamber 802 in which water 804 (or other solution) is disposed. The water (or solution) 804 may or may not be pure water. For instance, the solution may be an electrolyte including water. The pH of the water (or solution) 804 may vary accordingly. The container 802 may be configured to allow illumination of the water 804, such as solar illumination. The size, construction, composition, configuration, and other characteristics of the container 802 may vary. For instance, the container 802 may or may not be thermally insulated. The system 800 may not include a container in other cases.

The photocatalytic system 800 includes a semiconductor device 806 immersed in the water 804. In photocatalytic cases, the semiconductor device 806 is configured as a photocatalytic device as described herein. In the example of FIG. 8, the photocatalytic semiconductor device 806 is disposed in the container 802 in a manner to allow the incident light to illuminate the semiconductor device 806. In some cases, the photocatalytic semiconductor device 806 may be configured for photocatalytic water splitting in response to the illumination. In other cases, the semiconductor device 806 is not configured as a photocatalytic device, but nonetheless promotes the chemical reaction via, for instance, delivery of charge carriers provided via, e.g., an applied bias voltage.

The semiconductor device 806 includes a substrate 808 and an array 810 of conductive projections 812 supported by the substrate 808. In some cases, each conductive projection 812 is or includes a nanowire or other nanostructure. In this example, each conductive structure 812 is or includes a cylindrically shaped nanostructure. The cylindrical shape has a circular cross-sectional shape (e.g., a circular cylinder), as opposed to, for instance, a plate-shaped or sheet-shaped nanostructure. The conductive projections 812 may thus be configured, and/or referred to herein, as nanowires. The nanowires 812 extend outward from a surface 814 of the substrate 808.

The substrate 808 may be active (e.g., functional) and/or passive (e.g., structural). In one example of the former case, the substrate 808 may be or include a reflective material or layer to direct light back toward the nanowires 812. In one example of the latter case, the substrate 808 may be configured and act solely as a support structure for the nanowires 812. Alternatively or additionally, the substrate 808 may be composed of, or otherwise include, a material suitable for the growth or other deposition of the nanowires 812.

The substrate 808 may include a light absorbing material. In such cases, the light absorbing material is configured to generate charge carriers upon solar or other illumination. The light absorbing material has a bandgap such that incident light generates charge carriers (electron-hole pairs) within the substrate. Some or all of the substrate 808 may be configured for photogeneration of electron-hole pairs.

The substrate 808 may include a semiconductor material. In some cases, the substrate 808 is composed of, or otherwise includes, silicon. For instance, the substrate 808 may be provided as a silicon wafer. The silicon may or may not be doped. The doping arrangement may vary. For example, one or more components of the substrate 808 may be non-doped (intrinsic), or effectively non-doped. The substrate 808 may include alternative or additional layers, including, for instance, support or other structural layers. The composition of the substrate 808 may thus vary. For example, the substrate may be composed of, or otherwise include, metal films, GaAs, GaN, or SiOₓ in other cases.

The substrate 808 may establish a surface, e.g., the surface 814, at which a catalyst arrangement (e.g., a photocatalyst arrangement) of the semiconductor device 806 is provided. The photocatalyst arrangement is provided by the nanowires 812 of the array 810. In some cases, the catalyst arrangement may be a co-catalyst arrangement including a nanowire-nanoparticle architecture, as described below.

Each nanowire 812 has a semiconductor composition for photocatalytic water splitting. The semiconductor composition establishes a photochemical diode. In some cases, the semiconductor composition includes III-nitride semiconductor materials, such as gallium nitride (GaN) and/or one or more alloys of indium gallium nitride (InGaN). Additional or alternative semiconductor materials may be used, including, for instance, indium nitride, indium gallium nitride, aluminum nitride, boron nitride, aluminum oxide, and silicon, gallium phosphide, gallium arsenide, indium phosphide, tantalum nitride, silicon, and other semiconductor materials.

Each nanowire 812 may be or include a columnar, rod-shaped, post-shaped, or other elongated structure. The nanowires 812 may be grown or formed as described in U.S. U.S. Pat. No. 8,563,395 (“Method of growing uniform semiconductor nanowires without foreign metal catalyst and devices thereof”), the entire disclosure of which is hereby incorporated by reference. The dimensions (e.g., length, diameter), size, shape, and other characteristics of the nanowires 812 may vary.

In one example, InGaN/GaN nanowires were grown on a 3-inch silicon wafer (or substrate) by molecular beam epitaxy. The silicon wafer was first cleaned with acetone and 10% buffered hydrofluoric acid. Then residual oxide on silicon wafer was removed by an in-situ annealing at about 787° C. in the reaction chamber before growth. The InGaN/GaN nanowires were spontaneously grown on the silicon wafer under nitrogen-rich conditions to promote the formation of N-rich surfaces to prevent photo-corrosion and oxidation. Ga, In and Mg fluxes were controlled by using thermal effusion cells, while nitrogen radicals were produced from a radio-frequency nitrogen plasma source. Multi-stack InGaN/GaN layers were grown on a bottom or seed GaN layer and finally terminated by a GaN capping layer. A nitrogen flow rate of 1.0 sccm and a forward plasma power of about 350 W were used in the growth process. The growth temperatures of GaN and InGaN may be about 820° C. and about 765° C., respectively. The growth temperatures may vary in other examples, including, for instance, cases in which other semiconductors are used. Other aspects of the nanowire growth, heterostructure stack, or array may also vary, including, for instance, the composition of the substrate, seed layer(s), and capping layer(s).

The semiconductor composition of each nanowire 812 establishes a photochemical diode. As described herein, each nanowire 812 may be configured to have an anode side or surface 816 and a cathode side or surface 818. The anode and cathode sides 816, 818 may be parallel, opposing sides of the nanostructure, as shown. A photochemical diode may be established between the anode and cathode sides 816, 818 of a single one of the nanowires 812. As described herein, the water oxidation reaction (2H₂O->O₂+4H⁺+4e⁻) of the water splitting occurs along the anode side 816. The proton reduction reaction (4H⁺+4e⁻->2H₂) of the water splitting occurs at the cathode side 818. Proton diffusion from the water oxidation reaction to the proton reduction reaction may occur across a single one of the nanowires 812. Alternatively or additionally, the proton diffusion may occur between two adjacent nanowires 812 in the array 810. As described herein, the configuration of the array 810 may be useful for promoting water splitting involving a pair of the nanowires 812 due to the proximity of the anode and cathode sides 816, 818 of the pair.

Each nanowire 812 extends outward from the surface 814 of the substrate 808. In this example, the surface 814 of the substrate 808 is nonplanar such that subsets 820 of the array 110 are oriented at different angles. As shown in FIG. 1, the nanowires 812 in each subset 820 may be oriented in parallel with one another.

In the example of FIG. 1, the surface 814 is a multi-faceted surface. Each subset 820 of the array 110 extends outward from a respective face of the surface 814. The faces of the surface 814 may be defined in accordance with the manner in which the device 106 is fabricated. For example, if the substrate 808 is or includes a silicon wafer of <100> orientation, a wet etch procedure may result in a pyramidal textured surface. In such cases, the pyramids of the surface 814 are square-based pyramids with four sides defined by the <111> crystallographic planes. Each subset 820 of the array 110 extends outward from a respective face of each pyramid. Examples of the subsets 820 of a nanowire array 110 projecting outward from the facets or faces of a pyramidal or other textured surface are shown and described in connection with FIGS. 4 and 8.

The manner in, or degree to, which the surface 814 is multi-faceted or otherwise nonplanar may vary. For instance, the surface 814 may have any number of faces oriented at any angle. The pyramids or other shapes along the surface 814 may be uniform or non-uniform. For example, an etch procedure used to define the surface 814 may etch the substrate 808 at different rates in different locations. The nonplanarity of the surface 814 may vary in accordance with the manner in which the surface 814 is defined or formed. For example, a mold may be used to define a profile or contour for the surface 814. In these and other ways, any desired morphology may thus be achieved.

In other cases, the surface 814 of the substrate 808 is planar, flat, or otherwise non-faceted.

The nanowires 812 may be configured to generate electron-hole pairs upon illumination. The nanowires 812 may be configured to generate the electron-hole pairs upon absorption of light at certain wavelengths. In some cases, each nanowire 812 may be configured to absorb light over a wide range of wavelengths and, thus, improve the efficiency of the photocatalytic water splitting. For instance, each nanowire 812 may include a layered arrangement of semiconductor materials. Each layer in the arrangement may be configured for absorption of light of different wavelengths.

The layered arrangement of semiconductor materials is used to establish a multi-band structure, such as a quadruple band structure. Each layer or segment of the arrangement may have a different semiconductor composition to establish a different bandgap. For instance, in III-nitride examples, the layers or segments of the arrangement may have different indium and gallium compositions. Examples of layered arrangements configured to provide a quadruple band structure are shown and described in connection with FIGS. 5, 6, and 13.

The layered arrangement of the nanowires 812 may vary from the examples described herein. For example, further details regarding the formation and configuration of multi-band structures, including, for instance, triple-band structures, are provided in U.S. Pat. No. 9,112,085 (“High efficiency broadband semiconductor nanowire devices”) and U.S. Pat. No. 9,240,516 (“High efficiency broadband semiconductor nanowire devices”), the entire disclosures of which are incorporated by reference.

The semiconductor composition of each nanowire 812 may be configured to improve the efficiency of the water splitting in additional ways. For instance, in some cases, the semiconductor composition of each nanowire 812 may include doping to promote charge carrier separation and extraction, as well as to facilitate the establishment of a photochemical diode (e.g., to promote charge carrier separation and extraction). For example, a dopant concentration of the semiconductor composition may vary laterally and/or from layer to layer. In the example of FIG. 1, the dopant concentration decreases from the anode side 816 to the cathode side 818 to establish a lateral dopant gradient.

The dopant gradient may be formed during fabrication as a result of the angled orientation of the nanowires 812. As shown in FIG. 1, the anode side 816 faces away from the substrate 808, and thus toward a dopant source. In contrast, the cathode side 818 faces toward the substrate 808, and thus away from the dopant source. The anode sides 816 of the nanowires 812 are consequently more heavily doped.

In examples involving III-nitride compositions, the dopant may be or include magnesium. Further details regarding the manner in which magnesium doping promotes charge carrier separation and extraction are set forth in U.S. Pat. No. 10,576,447 (“Methods and systems relating to photochemical water splitting”), the entire disclosure of which is incorporated by reference. Additional or alternative dopant materials may be used, including, for instance, silicon, carbon, zinc, and beryllium, depending on the semiconductor light absorber of choice.

The semiconductor device 106 may further include one or more types of catalyst nanoparticles 822, 824 disposed over the array 110 of nanowires 812. Pluralities of each type of the nanoparticles 822, 824 are disposed on each nanowire 812, as schematically shown in FIG. 1. The nanoparticles 822, 824 are distributed across or along the outer surface (e.g., sidewalls) of each nanowire 812. In the example of FIG. 1, one type of nanoparticle 822 is disposed on the anode side 816 of each nanowire 812, and another type of nanoparticle 824 is disposed on the cathode side 818 of each nanowire 812. The nanoparticles 822 are configured to facilitate or promote the water-oxidation reaction. The nanoparticles 824 are configured to facilitate or promote the proton reduction reaction. Further details regarding the formation, configuration, functionality, and other characteristics of nanoparticles in conjunction with a nanowire array are set forth in one or more of the above-referenced U.S. patents.

In some cases, the nanoparticles 822 on the water-oxidizing anode side 816 are composed of, or otherwise include, cobalt oxide. The nanoparticles 824 on the proton-reducing cathode side may be composed of, or otherwise include, rhodium (Rh). For example, the Rh-based nanoparticles may have a core-shell configuration in which a Rh core is surrounded by a shell, such as a shell composed of, or otherwise including, chromium oxide (Cr₂O₃). However, additional or alternative materials may be used, including, for instance, iridium oxide, copper oxide, and nickel oxide for water oxidation, and platinum, gold, nickel, palladium, iron, and copper for proton reduction. Further details regarding the composition, formation, configuration, functionality, and other characteristics of core-shell and other co-catalyst nanoparticles are set forth in one or more of the above-referenced U.S. patents.

In one example, Rh/Cr₂O₃ core/shell and Co₃O₄ nanoparticles were loaded on InGaN/GaN nanowires by an n-situ photo-deposition procedure. In this case, a 0.8 cm by 0.8 cm photocatalyst wafer was firstly stabilized on a teflon holder. Then the holder was transferred to a chamber containing 50 mL of 20 vol % methanol aqueous solution. 5 μL of 0.2 mol L⁻¹ Na₃RhCl₆ (Sigma-Aldrich) was added into the methanol aqueous solution. The chamber was covered by a quartz cover and vacuumized. After that, the chamber was irradiated under a 300 W Xe lamp (Cermax, PE300BUV) for 10 min. After the reaction, 5 μL of 0.2 mol L⁻¹ K₂CrO₄ (Sigma-Aldrich) was injected into the chamber and the chamber was irradiated for another 10 min. Similarly, 5 μL of 0.2 mol L⁻¹ Co(NO₃)₂·6H₂O (Sigma-Aldrich) was also injected into the chamber and then irradiated for 20 min. Finally, the obtained photocatalyst wafer was washed by deionized water and dried at 80° C. in air. It should be noted that the deposited metallic Co nanoparticles in photoreduction can be readily oxidized in air, which were finally converted into Co₃O₄ nanoparticles. For the above-described outdoor test, the Rh/Cr₂O₃ core/shell and Co₃O₄ nanoparticles were loaded on the 4.0 cm×4.0 cm photocatalyst wafer by using 125 μL of 0.2 mol L⁻¹ Na₃RhCl₆, 125 μL of 0.2 mol L⁻¹ K₂CrO₄, 50 mL of 500 μmol L⁻¹ Co(NO₃)₂·6H₂O in the photo deposition. The parameters of the photo-deposition procedure may vary from those described above, including, for instance, in cases in which the composition of the nanoparticles is different.

The nanoparticles 822, 824 may be sized in a manner to facilitate the water splitting. The size of the nanoparticles 822, 824 may be useful in catalyzing the reaction, as described herein. The size of the nanoparticles 822, 824 may promote the water splitting in additional or alternative ways. For instance, the nanoparticles 822, 824 may also be sized to avoid inhibiting the illumination of the nanowires 812.

The distribution of the nanoparticles 822, 824 may be uniform or non-uniform. The nanoparticles 822, 824 may thus be distributed randomly across each nanowire 812. The schematic arrangement of FIG. 1 is shown for ease in illustration.

The nanowires 812 and the nanoparticles 822, 824 are not shown to scale in the schematic depiction of FIG. 1. The shape of the nanowires 812 and the nanoparticles 822, 824 may also vary from the example shown. Further details regarding the nanowire-nanoparticle co-catalyst arrangement, including the fabrication thereof, are provided below.

The nanoparticle-nanowire co-catalyst arrangement may be fabricated on a substrate (e.g., a silicon substrate) via nanostructure-engineering. In one example, molecular beam epitaxial (MBE) growth of the nanowires is followed by photo-deposition of the nanoparticles. The photo-deposition of the nanoparticles may be configured to selectively deposit the nanoparticles on the respective sides of the nanowire. Alternative or additional fabrication procedures may be used to provide the co-catalyst arrangement. For instance, the nanowires may be grown utilizing various other processes, such as chemical vapor deposition (CVD) and sputtering.

The nanowires 812 may facilitate the water splitting in alternative or additional ways. For instance, each nanowire 812 may be configured to extract charge carriers (e.g., electrons) generated in the substrate 808 (e.g., as a result of light absorbed by the substrate 808). In such cases, the opposite side of the substrate 808 may be configured for hole extraction. The extraction brings the charge carriers to external sites along the nanowires 812 for use in the water splitting or other reactions. For instance, the nanowires 812 may thus form an interface well-suited for reduction of CO₂, and/or other reactions.

Photocatalytic water splitting provided by the disclosed devices and systems may involve solar-to-hydrogen conversion. The disclosed devices and systems provide improvements in the efficiency of photocatalytic water splitting. The disclosed devices and systems may include multi-band (e.g., quadruple-band) for artificial photosynthesis and solar fuel conversion with significantly improved performance. For instance, the disclosed devices and systems may include InGaN nanowire arrays to improve the efficiency of the conversion. For example, each nanowire may include layers or segments of different semiconductor compositions, such as In_{0.35}Ga_{0.65}N, In_{0.27}Ga_{0.73}N, In_{0.20}Ga_{0.80}N, and GaN, which present energy bandgaps about 2.1 eV, 2.4 eV, 2.6 eV, and 3.4 eV, respectively. As described herein, such multi-band InGaN and other nanowire arrays are integrated directly on a nonplanar wafer for enhanced light absorption.

The configuration of the multi-band nanostructure arrays may vary. In some cases, the arrays include monolithically integrated quadruple-band InGaN nanostructures configured to act as photocatalysts. Each nanostructure may include Mg-doped (p-type) In_{0.35}Ga_{0.65}N (E_{g} of about 2.1 eV), In_{0.27}Ga_{0.73}N (E_{g} of about 2.4 eV), In_{0.20}Ga_{0.80}N (E_{g} of about 2.6 eV) and GaN (E_{g} of about 3.4 eV) segments. Each nanostructure may thus be capable of absorbing a wide range of the solar spectra, including, for instance, ultraviolet and visible portions of the solar spectra.

The system 800 may be integrated with any one or more of the systems described herein. For instance, the system 800 may include a thermal energy transfer control device as described above. The thermal transfer control device may be configured to implement a thermal energy transfer procedure to control a temperature of the water contained in the reaction chamber such that the temperature is maintained in a temperature range

The system 800 may include fewer, additional or alternative elements. For instance, the system 800 may include a lens device, such as the Fresnel lens described above. Other lens devices may be used. The lens device may be configured to focus solar radiation on the photocatalytic device to drive the photocatalytic water splitting and on the reaction chamber to heat the water contained in the reaction chamber. In another example, the system 800 includes a support stand or holder on which the photocatalytic device is disposed, as described herein. The solar radiation may be focused by the lens device on the support stand to heat the water contained in the reaction chamber.

Described herein are methods, systems, and devices for unassisted photocatalytic production of hydrogen and oxygen. Production of hydrogen and oxygen with a stoichiometric ratio of 2:1 in, e.g., pH neutral water, is useful for the development of clean and renewable energy. The photocatalytic solar-to-hydrogen (STH) efficiency achieved by the disclosed methods, systems, and devices is higher than previously reported levels (e.g., lower than 3%), which were limited by challenges arising from, e.g., simultaneously achieving a wide light-response range, high charge separation/transfer efficiency, low surface catalytic overpotential, and hydrogen-oxygen recombination in connection with photocatalyst materials. In contrast, the disclosed methods, systems, and devices implement a temperature-control technique to achieve higher STH efficiency levels (e.g., 9.17% in pH neutral water) using, e.g., InGaN-based photocatalytic devices. The efficiency enhancement may be provided by the synergistic effects of promoting forward hydrogen-oxygen evolution reaction and inhibiting the reverse hydrogen-oxygen recombination reaction. In some cases, the efficiency enhancement was achieved by utilizing infrared light of the solar spectrum to achieve an optimal reaction temperature (e.g., about 70 degrees Celsius). In such cases, a STH efficiency of 7.35% was achieved using tap water. Moreover, an example of a large-scale photocatalytic system achieved a STH efficiency of 6.21% under concentrated natural solar light during outdoor testing. These examples demonstrate the feasibility of high efficiency unassisted photocatalytic overall water splitting for producing clean hydrogen fuels from water under natural solar light.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A method of promoting a chemical reaction, the method comprising:
immersing a device in a solution contained in a reaction chamber, the device comprising a substrate and a plurality of conductive projections supported by the substrate, each conductive projection of the plurality of conductive projections having a semiconductor composition;
irradiating the device to drive the chemical reaction; and
controlling a temperature of the solution contained in the reaction chamber such that the temperature is maintained in a temperature range closer to a boiling temperature of the solution than a freezing temperature of the solution.

2. The method of claim 1, wherein:
the chemical reaction comprises a photocatalytic reaction; and
the device is configured as a photocatalytic device to drive the photocatalytic reaction.

3. The method of claim 1, wherein:
irradiating the device comprises directing solar radiation to the device; and
controlling the temperature comprises directing the solar radiation to the device.

4. The method of claim 1, wherein controlling the temperature comprises focusing solar radiation.

5. The method of claim 1, wherein controlling the temperature comprises disposing a support stand on which the device rests in a focal plane of a lens device.

6. The method of claim 1, wherein controlling the temperature comprises circulating heated water into the reaction chamber.

7. The method of claim 1, wherein controlling the temperature comprises implementing a thermal energy transfer procedure.

8. The method of claim 1, wherein the reaction chamber is thermally insulated.

9. The method of claim 1, wherein the solution comprises water and the temperature range falls between about 60 degrees Celsius and 80 degrees Celsius.

10. The method of claim 1, wherein the solution comprises water and the temperature range falls between about 70 degrees Celsius and about 75 degrees Celsius.

11. The method of claim 1, wherein:
each conductive projection of the plurality of conductive projections comprises a nanowire; and
the semiconductor composition comprises indium gallium nitride doped with magnesium.

12. The method of claim 1, wherein:
the device further comprises first and second pluralities of catalyst nanoparticles disposed over each conductive projection of the plurality of conductive projections;
each catalyst nanoparticle of the first plurality of catalyst nanoparticles comprises cobalt oxide;
each catalyst nanoparticle of the second plurality of catalyst nanoparticles comprises a core and shell surrounding the Rh core; and
the core comprises rhodium (Rh) core and the shell comprises chromium oxide.

13. A method of promoting a chemical reaction, the method comprising:
immersing a device in a solution contained in a reaction chamber, the device comprising a substrate and a plurality of conductive projections supported by the substrate, each conductive projection of the plurality of conductive projections having a semiconductor composition;
irradiating the device with solar radiation to drive the chemical reaction; and
heating the solution contained in the reaction chamber with the solar radiation.

14. The method of claim 13, wherein:
the chemical reaction comprises a photocatalytic reaction; and
the device is configured as a photocatalytic device to drive the photocatalytic reaction.

15. The method of claim 13, wherein heating the solution comprises controlling a temperature of the solution contained in the reaction chamber such that the temperature is maintained in a temperature range closer to a boiling temperature of the solution than a freezing temperature of the solution.

16. The method of claim 13, wherein the solution comprises water and the temperature range falls between about 60 degrees Celsius and 80 degrees Celsius.

17. The method of claim 13, wherein heating the solution comprises focusing the solar radiation on the reaction chamber.

18. The method of claim 13 wherein:
each conductive projection of the plurality of conductive projections comprises a nanowire;
the semiconductor composition comprises indium gallium nitride doped with magnesium;
the device further comprises first and second pluralities of catalyst nanoparticles disposed over each nanowire;
each catalyst nanoparticle of the first plurality of catalyst nanoparticles comprises cobalt oxide;
each catalyst nanoparticle of the second plurality of catalyst nanoparticles comprises a core and shell surrounding the Rh core; and
the core comprises rhodium (Rh) core and the shell comprises chromium oxide.

19. A system for promoting a chemical reaction, the system comprising:
a reaction chamber;
a device disposed in the reaction chamber, the device being configured for driving the chemical reaction upon immersion in a solution contained in the reaction chamber, the device comprising a substrate and a plurality of conductive projections supported by the substrate, each conductive projection of the plurality of conductive projections having a semiconductor composition; and
a lens device configured to focus solar radiation on the device, on the reaction chamber, or on both the device and the reaction chamber, to heat the solution contained in the reaction chamber.

20. The system of claim 19, wherein:
the chemical reaction comprises a photocatalytic reaction;
the device is configured as a photocatalytic device to drive the photocatalytic reaction; and
the lens device is configured to focus the solar radiation on the device to drive the photocatalytic reaction.

21. The system of claim 19, wherein the reaction chamber is thermally insulated.

22. The system of claim 19, wherein:
the reaction chamber comprises a support stand on which the device is disposed; and
the lens device is configured to focus the solar radiation on the support stand to heat the solution contained in the reaction chamber.

23. A system for promoting a chemical reaction, the system comprising:
a reaction chamber;
a device disposed in the reaction chamber, the device being configured for driving the chemical reaction upon immersion in a solution contained in the reaction chamber, the device comprising a substrate and a plurality of conductive projections supported by the substrate, each conductive projection of the plurality of conductive projections having a semiconductor composition; and
a thermal transfer control device configured to implement a thermal energy transfer procedure to control a temperature of the solution contained in the reaction chamber such that the temperature is maintained in a temperature range closer to a boiling temperature of the solution than a freezing temperature of the solution.

24. The system of claim 23, further comprising a lens device configured to focus solar radiation on the device, on the reaction chamber, or on both the device and the reaction chamber, to heat the solution contained in the reaction chamber.

25. The system of claim 24, wherein:
the chemical reaction comprises a photocatalytic reaction;
the device is configured as a photocatalytic device to drive the photocatalytic reaction; and
the lens device is configured to focus the solar radiation on the device to drive the photocatalytic reaction.

26. A method of hydrogen production via water splitting, the method comprising:
immersing a photocatalytic device in a solution contained in a reaction chamber, the photocatalytic device comprising a substrate and a plurality of conductive projections supported by the substrate, each conductive projection of the plurality of conductive projections having a semiconductor composition, the solution comprising water;
irradiating the photocatalytic device to drive the water splitting of the water of the solution contained in the reaction chamber; and
controlling a temperature of the solution contained in the reaction chamber such that the temperature is maintained in a temperature range closer to a boiling temperature of the solution than a freezing temperature of the solution.
